(19) United States
(12) Patent Application Publication
(10) Pub. No.: US 2015/0127878 A1
(43) Pub. Date: May 7, 2015

(54) TUNNELED WINDOW CONNECTION FOR PROGRAMMED INPUT OUTPUT TRANSFERS OVER A SWITCH FABRIC

(71) Applicant: PLX Technology, Inc., Sunnyvale, CA (US)

(72) Inventors: Jack REGULA, Durham, NC (US); Nagarajan SUBRAMANIYAN, San Jose, CA (US); Jeffrey M. DODSON, Portland, OR (US)

(73) Assignee: PLX Technology, Inc., Sunnyvale, CA (US)

(21) Appl. No.: 14/073,491

(22) Filed: Nov. 6, 2013

(51) Int. Cl. G06F 13/40; G06F 13/42

(52) U.S. Cl. CPC G06F 13/4022; G06F 13/4221
USPC 710/316

(57) ABSTRACT

Tunneled window connections are utilized in a switch fabric to perform programmed input output transfers. The window connections are based on global IDs. A management entity may enforce the tunneled window connections, improving security.

### FIELD OF THE INVENTION

The present invention is generally related to techniques for programmed input output transfers over a switch fabric.

### BACKGROUND OF THE INVENTION

Non-transparent bridging first appeared in the late 1990's in the form of the DEC (Digital Equipment Corp.) “Drawbridge”, later marketed by Intel Corp as the 21555 Bridge. Non-transparent bridging on PCI Express is described in several articles authored by technical staff at PLX Technology of Sunnyvale, Calif. (See “Using Non-transparent Bridging in PCI Express Systems” by Jack Regula, 2004; “Non-Transparent Bridging Makes PCI-Express HA Friendly,” by Akber Kazmi, EE Times, Aug. 14, 2003, the contents of each which is hereby incorporated by reference). Non-transparent bridging has also been described in a series of publicly available webcasts entitled “Utilizing Non-Transparent Bridging in PCI Express Base™ to Create Multi Processor Systems”, offered through TechOnline in October of 2003 (See Business Wire, Oct. 14, 2003 “PLX To Provide In-Depth Webcast October 21 on Implementing PCI Express In Multiprocessor Systems”, quoting Jack Regula)

Non-transparent bridging provides mechanisms for programmed input output access between two nodes based on memory address translations and address routing. A non-transparent bridge may have an intelligent device on both sides of a bridge, each with its own independent address domain. In a non-transparent bridging environment, there is a need to translate addresses that cross from one memory space to another. However, the inventors of the present application have recognized that the address-based approach of non-transparent bridging has problems in regards to scalability, performance, and manageability, especially for Peripheral Component Interconnect (PCI) Express switch fabrics and PLX Technology's implementation of Express Fabric. Therefore, in view of these drawbacks, a new approach is desired to implement tunneled window connections for PCI Express Fabric.

### SUMMARY OF THE INVENTION

Tunneled window connections are utilized in a switch fabric to perform programmed input output transfers. The window connections are based on global IDs.

In one implementation, a method of performing a programmed input output transfer in a PCI Express Fabric is disclosed that includes defining visibility of at least one host end point to other host end points of a switch or switch fabric, including defining windows on these host endpoints and connections between them. Tunneled PIO transfers between connected windows by routing the PIO transfer between window segments of host end points based on a global ID.

In another implementation, a method of performing a programmed input output (PIO) transfer in a PLX Express Fabric is disclosed in which a management entity defines tables in a global management end point of a switch and in host end points of the switch, the tables defining mappings between window segments of the initiating node and windows of the target node for routing transactions based on a global ID. The method includes performing a transaction between two end points of the switch fabric by routing the transaction based on a global ID

In another implementation, a PLX Express Fabric switch is disclosed. The switch includes a port for connection to a management entity or an internal management entity. The switch includes a global end point having a segmented base address register and a segment mapping table. A set of host end points is communicatively coupled to the global end point manager, each host end point having ingress and egress lookup tables. The segment mapping table and the ingress and egress lookup tables are programmed to define window connections between end points for programmed input output transactions.

### BRIEF DESCRIPTION OF THE DRAWINGS

FIG. 1 illustrates a management CPU view of tunneled window connections in accordance with an embodiment of the present invention.

FIG. 2 illustrates the use of a segment mapping table to direct incoming traffic to a tunneled window connection host end point in accordance with an embodiment of the present invention.

FIG. 3 illustrates outgoing traffic from a tunneled window connection host end point in accordance with an embodiment of the present invention.

FIG. 4 is a flowchart for the access of a window in a host's memory by the MCPU. It describes a tunneled window connection between a management endpoint and a tunneled window connection host end point in accordance with an embodiment of the present invention.

FIG. 5 is a flowchart of a tunneled window connection host end point to another host end point in accordance with an embodiment of the present invention.

### DETAILED DESCRIPTION

The present invention is generally directed to an application of a Tunneled Window Connection (TWC) mechanism for programmed I/O transfers (PIO) between nodes of a switch fabric using a connection oriented transfer mechanism based on ID routing through a global ID space.

In one embodiment, registers at initiator and target nodes define a connection between memory address apertures at both nodes so that load/store transfer commands can be tunneled through the switch fabric between initiator and target nodes with security, using ID routing. Multiple such connections can be stored at both initiator and target nodes and organized into tables. Connections are unidirectional tunnels for the transport of a memory request packet, which can be for a read or a write transfer, from an initiating node to a target node. Typically, each window at the initiator node is a segment of a Base Address Register (BAR) which is connected to an arbitrarily located window in the target node. The registers at the initiator node include the ID route to the target node. The registers at the target node include the ID of the initiator node at the other end of the connection, for use in access permission checking. Thus, the TWC mechanism improves security and provides other benefits, such as eliminating the burden of performing conventional memory address translations for PIO transfers. An exemplary application is in a PLX Express-Fabric™ environment, although it will be understood that other fabric environments are contemplated. The PLX Express-Fabric™ environment is promoted by PLX Technology, Inc. of Sunnyvale, Calif. and is described in white papers and other published papers describing the ExpressFabric® initiative, including the following articles incorporated by reference: “PLX Looks to Bring PCIe Fabric to Market,” HPCwire, November 2012; “What Else Can PCI Express Do?”, RTC Magazine, November 2012; “PLX Preps PCI Express Fabric amid Server Debate,” EE Times, September 2012; and “PCI Express Fabric: Rethinking data center architectures,” Embedded Computing, August 2012.

In one embodiment, the Tunneled Window Connection mechanism acts as an interface to a switch fabric for a compute node that allows it to transfer data with other compute nodes on the fabric by standard load and store computer instructions without the need for address translation. In one embodiment, the TWC mechanism employs an indexed window access for the use of load and store instructions by a processor instead of a direct memory access mechanism, thus reducing software overhead and latency for transfers of small amounts of data at a time.

The TWC mechanism provides a means for registering memory buffers at both initiator and target nodes, and allowing only a single connected initiator to transfer data to or from the buffer. In one embodiment, the global ID of the target is registered with the initiator as packets transferred between the two nodes are routed by ID instead of by address. Because ID routing is used, it's not necessary to translate the address in order to route the packet to its destination. The global ID of the initiator is registered with the target so that other nodes may be prevented from transferring data with the buffer, thus providing security for the transfer. The location of the target buffer in the target's address space is also stored in the target's registry and used when a transfer request with a matching connection number is received and security checks are passed. Although ID routing is used in the preferred embodiment, multiple routing mechanisms other than address routing are contemplated.

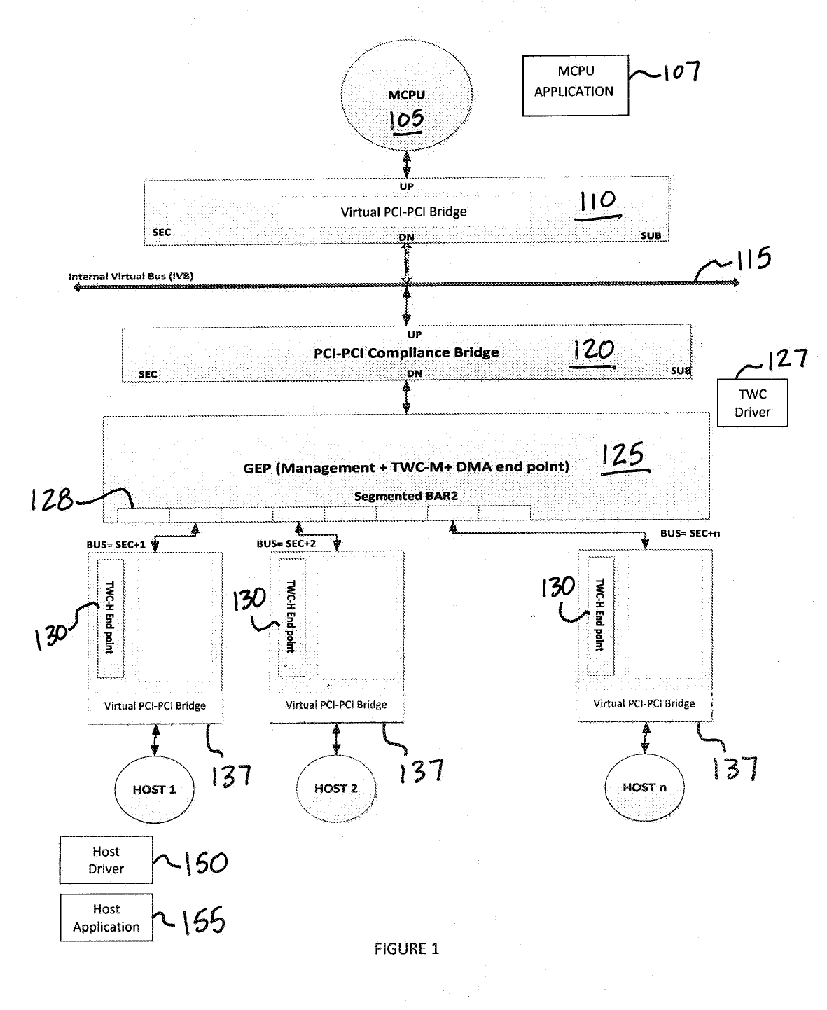

FIG. 1 illustrates a PCI Express Fabric switch, showing a management CPU (MCPU) 105 view of a tunneled window connection (TWC) between end points of a set of nodes in a PCI Express switch fabric, in accordance with an embodiment of the present invention. The MCPU 105 is coupled to a PCI-PCI Compliance bridge 120, which in one embodiment, is made via an internal virtual bus (IVB) 115 and a virtual PCI-PCI bridge 110. It will be understood that other conventional hardware and processor support may be provided to support the operation of the switch.

In one embodiment, a global end point (GEP) management unit 125 is coupled to the PCI-PCI Compliance bridge 120. In one implementation, the GEP is a full type zero endpoint and includes registers to support creating entries to define the window connections. The GEP management endpoint is to manage the switch itself, and internal DMA controllers in addition to serving as the TWC management end point. The management end point of each switch is thus the management end point for the TWC (TWC-M). A segmented base address register (BAR) (e.g. a BAR2 in one implementation) is provided to support the tunneled window connection function, where each individual segment of the BAR is mapped to the TWC-H of one of the host ports of the switch.

A set of hosts 1 to N is illustrated, each having corresponding host ports. Each of the host ports in the Express Fabric has a TWC host end point (TWC-H) 130, which is communicatively coupled via the data path of the switch to GEP management unit 125. The management policy, as set by a system administrator via a management entity (or EEPROM settings), will dictate if the TWC-H end point is visible to a particular host port or not. A virtual PCI to PCI bridge interface provides a connection to an individual host, where an individual host computing device has associated computing hardware and host driver 150 and host software application 155.

In one embodiment, the TWC Management of GEP management unit 125, as well as TWC host end points 130, have a single segmented (or windowed) BAR2 (and BAR3 for 64 bit BARs). Each of these segments (or more than one of them) can be pointed towards a window on a remote node.

In one embodiment, the MCPU, acting as a management entity, configures a connection between an outgoing address window at an initiating node, and an incoming address window at a target node, by configuring a table entry at each of the initiator and target nodes. The MCPU has associated software applications 107 and additionally, there may also be a management driver 127. In one embodiment, the connection process is initiated when an application on one node needs to exchange data with another node. The two nodes may exchange messages via a conventional mechanism (e.g., an application specific protocol over the switch fabric or any other available fabric; using mailboxes or scratch registers or broadcasts over any fabric/transport), and agree to the data exchange using specified or negotiated initiator and target connection numbers. This connection mechanism can also be arbitrated and finalized by a management entity.

In one embodiment, an initiator (node) performs a data transfer by executing a load or store operation using an address that maps to the Tunneled Window Connector (TWC) portal into the switch fabric. When the address is in the range that maps through the portal, the TWC hardware extracts a connection number from the address, looks up the target global ID (GID) and connection number in a table, and modifies the packet for transfer through the fabric in one of the following ways:
1. Convert the memory read/write request packet to a new packet with ID-routed Vendor Defined Message header with target node connection number, offset within window and the target's ID as fields. This packet can be ID routed through a PCIe switch fabric to the target node; and
2. The TWC can pre-pend the original packet with an ID routing prefix. In PLX Express Fabric, a PCIe Vendor Defined End to End prefix is used. This prefix contains the Target's global Domain and BUS numbers, sufficient subset of the Target GID to route to it, plus the Source's Domain number which is needed for the return ID route, if the packet is a read request. When using the prefix un-needed bits of the address may be discarded and replaced by the target's connection number.

If the initiator (node) and target (node) are in different Express Fabric Domains, then the ID routing prefix described above must be pre-pended to the packet even when using the Vendor Defined Message option described above to provide the Destination Domain for use in ID routing.

In one embodiment, the initiator's connection table entry is stored at an index corresponding to the initiator's connection number. It contains the global ID of the target node and the target's connection number. The target node's connection table entry is stored at the index corresponding to its connection number. It contains the initiator's global ID, a set of access permissions and a base address that specifies the location of the registered buffer in its memory space. The buffer may be configured for read only access, write only access, read and write access by any fabric node, or by only the node whose global ID is registered in the table entry.

In one embodiment, the initiator's request packet arrives at the target node. At this point, the ID routing prefix, if any, may be discarded. The target connection number is extracted from the header and used to retrieve the registered information. First, access permissions are checked. If the permission checks fail, the request is rejected by, in a PLX ExpressFabric™, treating it as an unsupported request (UR). If the checks are passed, then the target buffer base address is retrieved from the table and added to or concatenated with the buffer offset carried in the request packet header. The composite address is then used as the address in a standard PCIe memory request packet that is forwarded from the egress of the target host port of the switch to the target host itself.

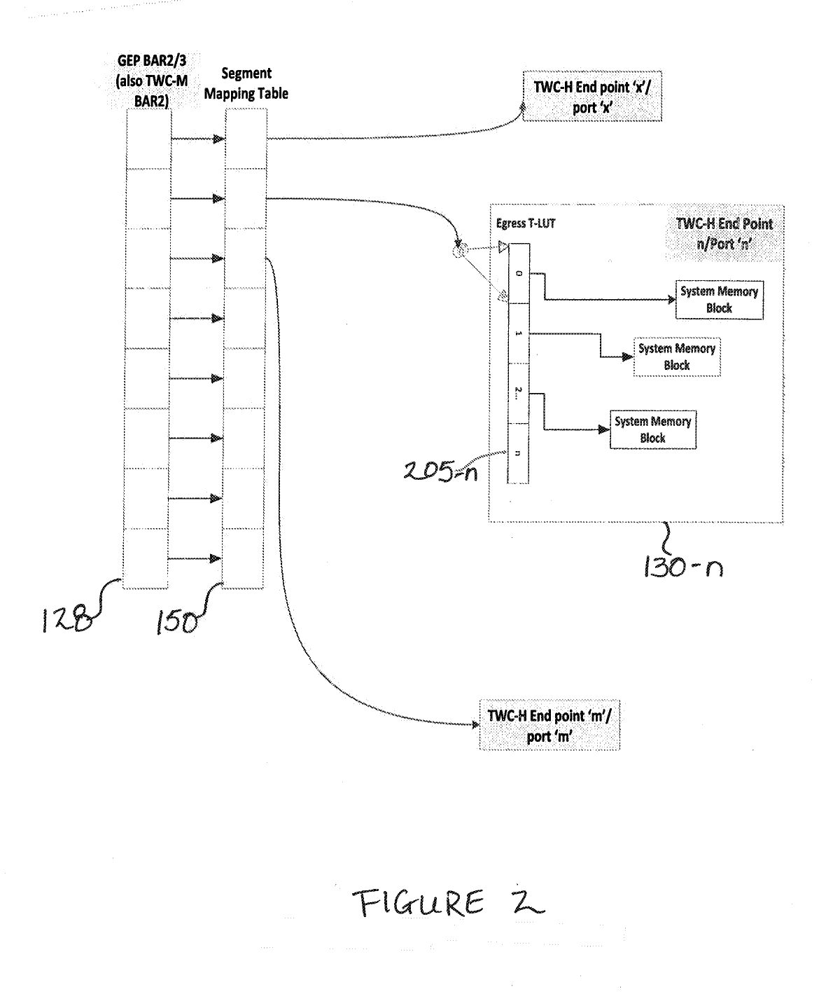

FIG. 2 illustrates the use of a Segment Mapping Table to associate each segment of the GEP BAR to one of the TWC-H endpoints of the switch. In one embodiment, the MCPU, and only the MCPU, uses address routing to initiate load/store transfers through host port TWC-H endpoints. The Segment Mapping Table supports these transfers by mapping the address range of each GEP BAR segment to a specific host port. On the TWC Management end point, the incoming address routed transfers are routed to individual TWC-H end points on the same switch by a Global Segment Mapping Table. The Global Segment Mapping Table allows an individual TWC management end point BAR2 segment to point to a specific TWC Host end point. In one implementation, this segment always goes to the Egress T-LUT entry 0 of the remote TWC Host end point as a default. That means a posted write by the TWC Management end point (same as GEP end point) BAR2 from the MCPU will land in the system memory allocated to the Egress A-LUT entry 0 of a host port for that segment.

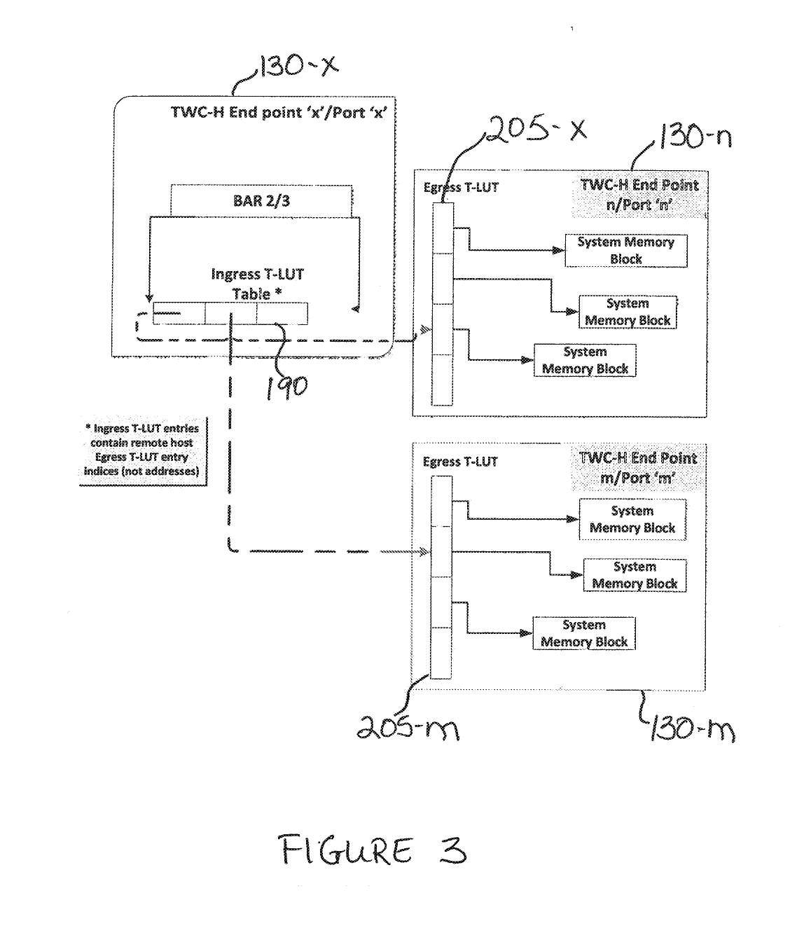

FIG. 3 illustrates tunneled window connections between the Ingress T-LUT of a TWC-H endpoint 130-H and the Egress T-LUT of two other TWC-H endpoints 130-n and 130-m potentially located in different switch chips elsewhere in the fabric, in accordance with embodiments of the present invention. Referring to FIG. 3, in one embodiment, the windows, connected via ID-routed tunneling, are managed through the Ingress and Egress T-LUT (Tunnel LUT) entries in each TWC Host end point. The routing through the fabric between the switch containing the initiating node and the switch containing the target node is based on ID routing in a global ID space for TWC (unlike the address routing for the earlier technology of Non Transparency).

As illustrated in FIG. 2, in one implementation, an individual TWC-H end point has an Egress T-LUT table 205 and local system memory blocks. In this example, the Egress T-LUT has 0, 1, 2, . . . n window entries, each corresponding to an entry in the T-LUT. The target connection number, which is part of the initiator's transfer request packet, points to the T-LUT entry number to be used to complete the transfer.

In one implementation, each TWC Host end point 130 does not share/have any global address range for address routing. A TWC Host end point 130 can only be reach from another TWC Host end point through a tunnel that targets one of the windows it exposes, using the global ID of that TWC Host end point. Note however as described earlier with regard to FIG. 2, that the MCPU, and only the MCPU, can target TWC host end points using address routing.

FIG. 3 illustrates traffic initiated by a TWC Host End point 130-x that targets TWC Host End points 130-n and 130-m, respectively. By programming its Ingress T-LUT 190, each TWC Host end point's BAR2 can be segmented and pointed to various windows of remote nodes in the fabric, such as nodes 130-n and 130-x. The ingress T-LUT 190 is used to access any other TWC Host end point in the fabric, but cannot be used to access the MCPU (TWC Management/GEP end point memory). To access MCPU memory, the MCPU can set up an address trap for one of the Ingress T-LUT entries to map directly to the MCPU memory space that is allocated for this purpose.

In some embodiments, additional drivers are used to support the TWC mechanism. In particular, TWC host drivers and a TWC management driver may be utilized to aid in supporting the TWC mechanism.

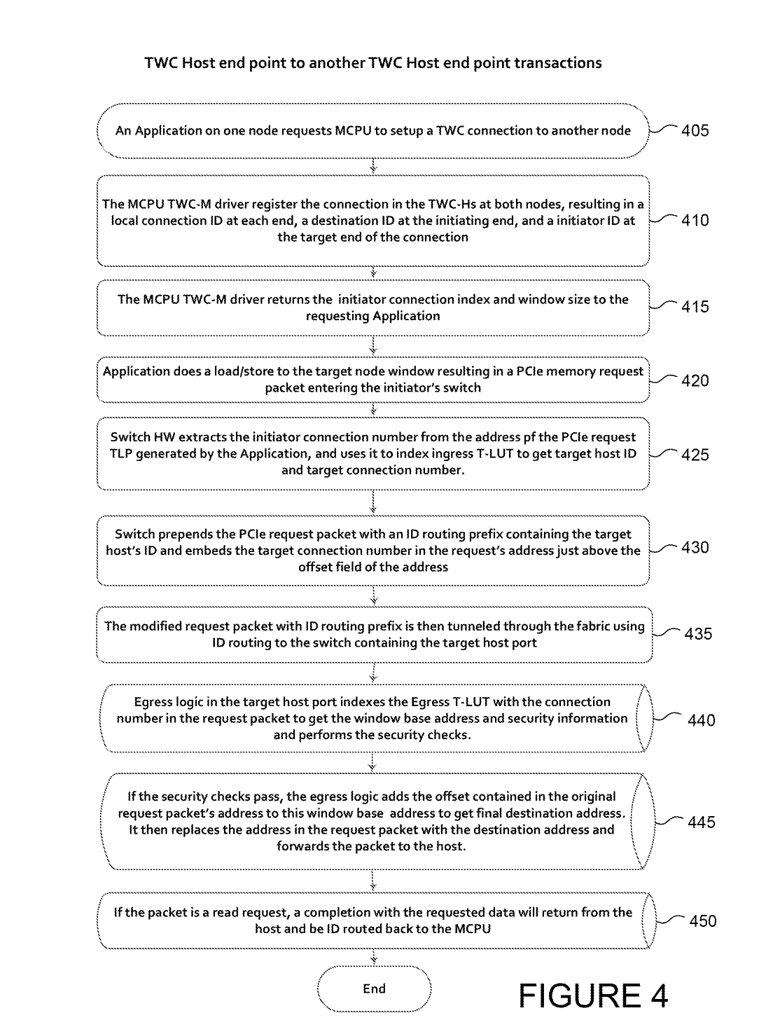

FIG. 4 is a flowchart illustrating a TWC host end point to another TWC host end point. In block 405, an application on one node requests MCPU to setup a TWC connection to another node. In block 410, the MCPU TWC-M driver registers the connection in the TWC-H at both nodes, resulting in a local connection ID at each end, a destination ID at the initiating end, and an initiator ID at the target end of the connection. At block 415, the MCPU TWC-M driver returns the initiator connection index and window size to the requesting application. In block 420, the application does a load/store to the target node window, resulting in a PCIe memory request packet entering the initiator's switch. In block 425, the switch HW extracts the initiator connection number from the address of the PCIe request TLP generated by the application, and uses it to index ingress T-LUT to get target host ID and target connection number. In block 430, the switch pre-pends the PCIe request packet with an ID routing prefix containing the target host's ID and embeds the target connection number in the request's address just above the field of the address. In block 435, egress logic in the target host port indexes the egress T-LUT with the connection number in the request packet to get the window base address and security information and performs the security checks. In block 440, if the security checks pass, the egress logic adds the offset contained in the original request packet's address to the window base address to get the final destination address. It then replaces the address in the request packet with the destination address and forwards the packet to the host. In block 445, if the packet is a read packet, a completion with the requested data will return from the host and to be ID routed back to the MCPU.

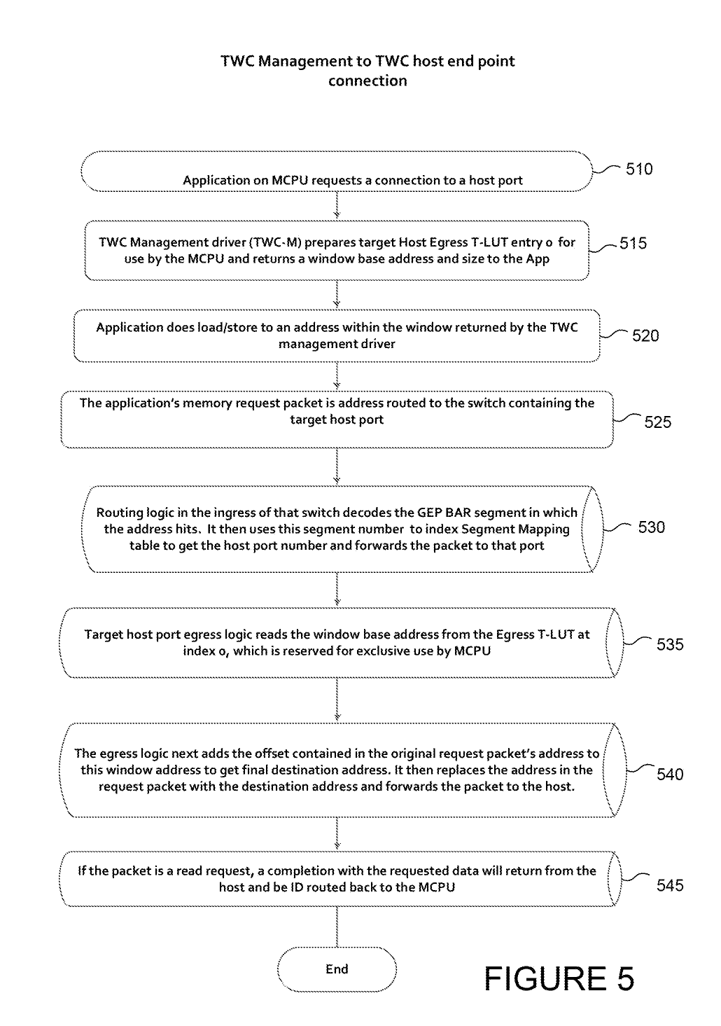

FIG. 5 is a flowchart illustrating the TWC management to a TWC host end point data path. In block 510, an application on the MCPU requests a connection to a host port. In block 515, the TWC management driver (TWC-M) prepares a target host egress T-LUT entry 0 for use by the MCPU and returns a window base address and size to the application. In block 520, the application does a load/store to an address within the window returned by the TWC management driver. In block 525, the application's memory request packet is address routed to the switch containing the target host port. In block 530, routing logic in the ingress of that switch decodes the GEP BAR segment in which the address hits. It then uses this segment number to index a segment mapping table to get the host port number and forwards the packet to that port.

For implementing a remote PIO memory access using a Tunneled Window Connection to the remote node, and routing that access by using the remote node ID instead of using remote addresses, has several benefits in comparison to Non Transparent Bridging. One benefit of this method is that addresses don't need to be translated in order to be used for address routing through the fabric, unlike conventional non-transparent bridging.

Another benefit is that remote node addresses are also isolated, as the routing is only based on the remote node ID. Packets are routed through the PCIe fabric using ID routing, instead of address routing used by non-transparent bridging.

Moreover, the ID routing is scalable to hundreds or thousands of nodes without any system limitations.

Additionally, making these connections under the control of a management entity provides further security. Once it is secured by a management entity, a rogue TWC end point driver cannot access another host's memory. The security checks implemented by the management entity, together with hardware ID checking, prevent a rogue endpoint driver from accessing the memories of other hosts.

The security mechanisms apply at both the sending and receiving sides. The sender can target a remote node only if enabled/allowed to do so. The receiver can verify and authenticate the received data to make sure only an authorized sender is sending this data. The receiver can report security violations if it receives unsolicited data from a rogue node.

The TWC mechanism comes with increased security and robust features which cannot be applied on non-transparent bridging. This mechanism also supports the use of transfers across multiple PCIe BUS number Domains.

While embodiments of the invention have been described in the context of ExpressFabric to illustrate aspects of the invention, it will be understood that the invention is not limited to ExpressFabric. That is, the TWC mechanism can be implemented on PCI Express or any other fabric.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of performing a programmed input output (PIO) transfer in a switch fabric, comprising:
defining visibility of at least one host end point to other host end points of a switch or switch fabric, including defining windows on these host end points and connections between them; and
tunneling PIO transfers between connected windows by routing PIO transfer between window segments of host end points based on a global ID.

2. The method of claim 1, wherein the routing includes performing a lookup to at least one table defined by the management entity to access stored connection information and apply it to the routing of a packet between two host end points

3. The method of claim 1, further comprising creating a connection between an application on a management CPU and a remote host node, receiving a request from an application running on the MCPU for a load store operation with a remote host node, and routing the transaction through the fabric using a address based routing that targets the TWC-H endpoint of the remote node.

4. The method of claim 1, wherein the PIO transfer is between two host end points, the method further comprising:
receiving a request from an application at an initiating node to create a connection to a remote node;
receiving a request from the application for a load/store operation with the remote node; and
routing the transaction using a global ID.

5. The method of claim 1, further comprising pre-pending an original packet with an ID routing prefix.

6. The method of claim 1, further comprising extracting a connection number from an address and performing a lookup of a target global ID and connection number in a lookup up table.

7. The method of claim 6, further comprising modifying the packet for transfer through packet by pre-pending or converting the packet to include the global ID.

8. The method of claim 1, further comprising extracting connection information at the target node.

9. The method of claim 8, further comprising utilizing an indexed table access, based on the extracted connection information, in order to process the tunneled load/store transfer request at the target node

10. The method of claim 1, wherein a management end point utilizes a segmented base address register and a segment mapping table to direct incoming traffic to a host end point.

11. The method of claim 10, wherein a host end point includes a segmented base address register to point to windows of other remote nodes.

12. A method of performing a programmed input output (PIO) transfer in a PLX Express Fabric, comprising:
defining, by a management entity, tables in a global management end point of a switch and in host end points of the switch, the tables defining mappings between window segments of the initiating node and windows of the target node for routing transactions based on a global ID; and
performing a transaction between two end points of the switch fabric by routing the transaction based on a global ID.

13. The method of claim 12, wherein the management entity programs Ingress Tunnel Lookup Tables and Egress Tunnel Lookup Tables in host end points.

14. The method of claim 13, wherein a segment mapping table of the global management end point directs incoming traffic to Egress Lookup Table of a host end point.

15. The method of claim 13, wherein an Ingress Tunnel Lookup Table contains remote host Egress Lookup Table Entry indices to direct traffic at remote nodes.

16. A PLX Express Fabric Switch, comprising:
a port for connection to a management entity or an internal management entity;
a global end point having a segmented base address register and a segment mapping table; and
a set of host end points communicatively coupled to the global end point manager, each host end point having ingress and egress lookup tables;
wherein the segment mapping table and the ingress and egress lookup tables are programmed to define window connections between end points for programmed input output transactions.

17. The switch of claim 16, wherein the segment mapping table and the ingress and egress lookup tables are programmed by a management entity.

18. The switch of claim 16, wherein the segment mapping table and the ingress and egress lookup table are programmed as data structures by serial EEPROM.

19. The switch of claim 17, wherein the hardware of the switch routes a transaction between a pair of connected windows based on a global ID.

20. The switch of claim 17, wherein the window connection is defined between two host end points to tunnel transactions between the host end points.

21. The switch of claim 17, where the window connection is defined between the global end point manager and an individual host end point.

22. The method of claim 1, wherein the switch fabric is a PCI Express Fabric.
